(19) United States
(12) Patent Application Publication
(10) Pub. No.: US 2019/0208487 A1
(43) Pub. Date: Jul. 4, 2019

(54) MOBILE COMMUNICATION SYSTEM, BASE STATION DEVICE, VEHICLE, TERMINAL DEVICE, COMMUNICATION METHOD, AND PROGRAM

(71) Applicant: SHARP KABUSHIKI KAISHA, Sakai City (JP)

(72) Inventors: KENNICHI IIJIMA, Sakai City (JP); SHIGETO SUZUKI, Sakai City (JP); MAKOTO YAMAMOTO, Sakai City (JP)

(21) Appl. No.: 16/232,941

(22) Filed: Dec. 26, 2018

(30) Foreign Application Priority Data
Jan. 4, 2018 (JP) 2018-000283

(51) Int. Cl. H04W 60/00; H04W 16/18; H04W 48/16; H04W 8/08

(52) U.S. Cl. CPC H04W 60/00; H04W 16/18; H04W 84/005; H04W 8/08; H04W 48/16

(57) ABSTRACT

A mobile communication system includes: a terminal device; a base station device configured to communicate with the terminal device by forming a cell; and an area detection unit configured to detect a location registration area to which the base station device belongs. In a case that the area detection unit has detected a change in the location registration area to which the base station device belongs, the base station device is configured to change cell identification information of the cell formed by the base station device from first cell identification information usable in a location registration area before the change to second cell identification information usable in a location registration area after the change.

### BACKGROUND OF THE INVENTION

### Field of the Invention

An aspect of the present invention relates to a mobile communication system, a base station device, a vehicle, a terminal device, a communication method, and a program.

### Description of Related Art

Conventionally, technology for managing approximate locations of moving terminal devices in a mobile communication system is known. For example, a mobile communication system described in Patent Document 1 includes a location registration processing device configured to perform a location registration process on terminal devices. The location registration processing device executes a location registration process on a terminal device in accordance with reception of a location registration request transmitted from a base station device in a case that the terminal device is located in a location registration area without executing the location registration process in a case that a location registration request has been received from the terminal device.

### PATENT DOCUMENTS

[Patent Document 1] Japanese Unexamined Patent Application, First Publication No. 2013-157859

### SUMMARY OF THE INVENTION

However, in a case that a base station device is mounted on a vehicle such as a train or a bus, the base station device is assumed to move across a location registration area while maintaining a connection with a terminal device.

In a case that the base station device has moved across the location registration area while continuing the connection with the terminal device, the location registration area corresponding to the terminal device registered in the location registration processing device may be different from a location registration area where the terminal device is actually located. However, in a location registration process of Patent Document 1, in a case that the base station device and the terminal device have moved across a location registration area, the location registration area where the base station device and the terminal device are actually located are different from the location registration area registered in a location registration processing device.

The present invention has been made based on the above-described problems, and an objective of the present invention is to provide a mobile communication system, a base station device, a vehicle, a terminal device, a communication method, and a program capable of shortening a period in which location registration areas are different from each other in a case that a base station device and a terminal device have moved across a location registration area.

(1) To solve the above-described problem, a mobile communication system according to one aspect of the present invention includes: a terminal device; a base station device configured to communicate with the terminal device by forming a cell; and an area detection unit configured to detect a location registration area to which the base station device belongs, wherein, in a case that the area detection unit has detected a change in the location registration area to which the base station device belongs, the base station device is configured to change cell identification information of the cell formed by the base station device from first cell identification information usable in a location registration area before the change to second cell identification information usable in a location registration area after the change.

(2) In the mobile communication system according to one aspect of the present invention, the second cell identification information may be selected from cell identification information other than cell identification information already used in other base station devices among a plurality of pieces of cell identification information that are able to be used by the base station device located within the location registration area after the change.

(3) In the mobile communication system according to one aspect of the present invention, a plurality of base station devices belonging to the same location registration area may form a cell using the same cell identification information in the location registration area in time slots that do not overlap.

(4) To solve the above-described problem, a mobile communication system according to one aspect of the present invention includes: a terminal device; a base station device configured to communicate with the terminal device by forming a cell; and an area detection unit configured to detect a location registration area to which the base station device belongs, wherein, in a case that the area detection unit has detected a change in the location registration area to which the base station device belongs, the base station device is configured to form a new cell using cell identification information usable in a location registration area after the change.

(5) To solve the above-described problem, in a base station device, according to one aspect of the present invention, for communicating with a terminal device by forming a cell, the base station device includes: an area information acquisition unit configured to acquire information about a location registration area to which the base station device belongs; a communication unit configured to communicate with the terminal device; and a control unit, wherein, in a case that a change in a location registration area to which the base station device belongs has been detected, the control unit is configured to change cell identification information of the cell formed by the base station device from first cell identification information usable in a location registration area before the change to second cell identification information usable in a location registration area after the change based on the information acquired by the area information acquisition unit.

(6) In the base station device according to one aspect of the present invention, the control unit may be configured to notify the terminal device connected to the base station device of the change via the communication unit in a case that the cell identification information has been changed.

(7) In the base station device according to one aspect of the present invention, the control unit may be configured to provide a notification of the second cell identification information via the communication unit in a case that the cell identification information has been changed.

(8) In the base station device according to one aspect of the present invention, the control unit may be configured to cause the communication unit to decrease power of radio waves to be output to a standard or less in a case that the change in the location registration area to which the base station device belongs has been detected.

(9) A vehicle according to one aspect of the present invention includes: the base station device according to the above-described section (5).

(10) In a vehicle, according to one aspect of the present invention, equipped with a base station device for communicating with a terminal device by forming a cell, in a case that a location registration area to which the base station device belongs has been changed, the base station device is configured to form a new cell using cell identification information usable in a location registration area after the change.

(11) To solve the above-described problem, in a terminal device, according to one aspect of the present invention, for use in a mobile communication system including the terminal device and a base station device for communicating with the terminal device by forming a cell, the terminal device includes: a reception unit configured to receive information based on a change in a location registration area to which the terminal device belongs from the base station device connected to the terminal device; and a change unit configured to change cell identification information for communicating with the base station device from first cell identification information usable in a location registration area before the change to second cell identification information usable in a location registration area after the change based on the information received by the reception unit.

(12) To solve the above-described problem, in a communication method for use in a mobile communication system including a terminal device and a base station device for communicating with the terminal device by forming a cell, the communication method includes: detecting a location registration area to which the base station device belongs; and changing, in a case that a change in a location registration area to which the base station device belongs has been detected, cell identification information corresponding to the base station device from first cell identification information usable in a location registration area before the change to second cell identification information usable in a location registration area after the change.

(13) To solve the above-described problem, in a communication method, according to one aspect of the present invention, for use in a mobile communication system including a terminal device and a base station device for communicating with the terminal device by forming a cell, the communication method includes: detecting a location registration area to which the base station device belongs; and forming, in a case that a change in the location registration area to which the base station device belongs has been detected, by the base station device, a new cell using cell identification information usable in a location registration area after the change.

(14) To solve the above-described problem, in a communication method, according to one aspect of the present invention, for use in a base station device for communicating with a terminal device by forming a cell, the communication method includes: acquiring information about a location registration area to which the base station device belongs; and changing, in a case that a change in a location registration area to which the base station device belongs has been detected, cell identification information of the cell formed by the base station device from first cell identification information usable in a location registration area before the change to second cell identification information usable in a location registration area after the change based on the acquired information.

(15) To solve the above-described problem, a non-transitory computer readable recording medium, according to one aspect of the present invention, storing a program for causing a computer of a base station device for communicating with a terminal device by forming a cell to: acquire information about a location registration area to which the base station device belongs; and change, in a case that a change in the location registration area to which the base station device belongs has been detected, cell identification information of the cell formed by the base station device from first cell identification information usable in a location registration area before the change to second cell identification information usable in a location registration area after the change based on the acquired information.

(16) To solve the above-described problem, a non-transitory computer readable recording medium, according to one aspect of the present invention, storing a program for causing a computer of a terminal device for use in a mobile communication system including the terminal device and a base station device for communicating with the terminal device by forming a cell to: receive information based on a change in a location registration area to which the terminal device belongs from the base station device connected to the terminal device; and change cell identification information for communicating with the base station device from first cell identification information usable in a location registration area before the change to second cell identification information usable in a location registration area after the change based on the received information.

According to an aspect of the present invention, it is possible to shorten a period in which location registration areas are different from each other in a case that a base station device and a terminal device have moved across a location registration area.

### BRIEF DESCRIPTION OF THE DRAWINGS

FIG. 1 is a block diagram illustrating an example of a configuration of a mobile communication system according to an embodiment.

FIG. 2A is a diagram illustrating a cell ID assigned to one location registration area.

FIG. 2B is a diagram illustrating a cell ID assigned to another location registration area.

FIG. 3 is a block diagram illustrating an example of a configuration of a terminal device.

FIG. 4 is a block diagram illustrating an example of a configuration of a base station device.

FIG. 5 is a block diagram illustrating an example of configurations of a base station control device and an information storage device.

FIG. 6 is a diagram illustrating an example of a sequence in the mobile communication system.

FIG. 7 is a block diagram illustrating an example of a configuration of a base station device according to a second embodiment.

FIG. 8 is a diagram illustrating another example of a sequence in the mobile communication system.

FIG. 9 is a block diagram illustrating an example of a configuration of a base station device according to a third embodiment.

FIG. 10 is a diagram illustrating another example of a sequence in the mobile communication system.

FIG. 11 is a block diagram illustrating an example of a configuration of a vehicle according to a fourth embodiment.

FIG. 12 is a diagram illustrating another example of the sequence in the mobile communication system.

FIG. 13 is a block diagram illustrating a modified example.

### DETAILED DESCRIPTION OF THE INVENTION

Hereinafter, a mobile communication system, a base station device, a vehicle, a terminal device, a communication method, and a program to which the present invention is applied will be described with reference to the drawings.

### First Embodiment

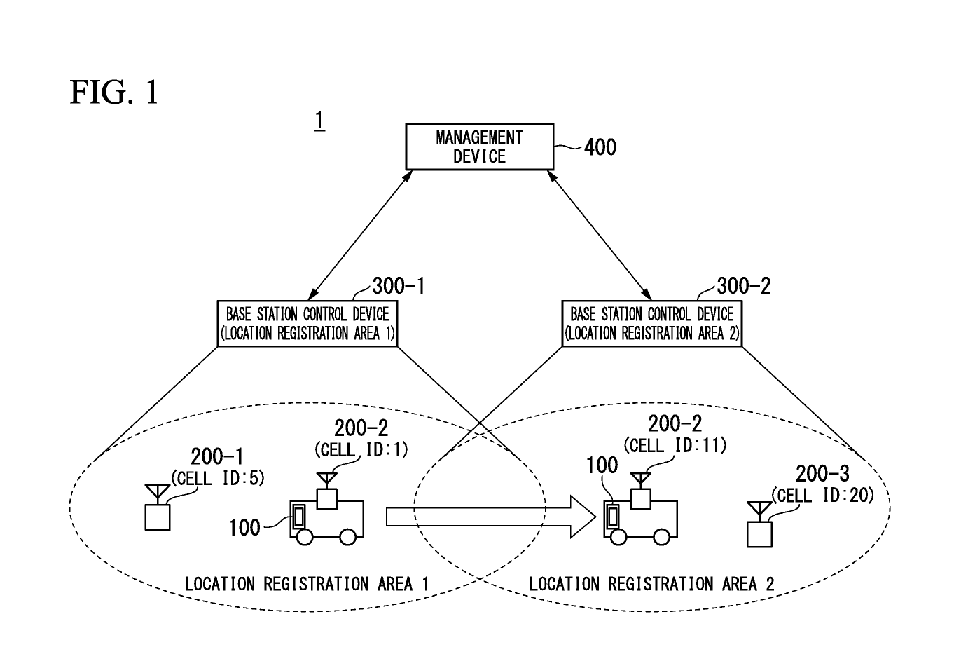

FIG. 1 is a block diagram illustrating an example of a configuration of a mobile communication system 1 according to an embodiment. The mobile communication system 1 includes, for example, a terminal device 100, a plurality of base station devices 200-1, 200-2 and 200-3, a plurality of base station control devices 300-1 and 300-2, and a management device 400. The plurality of base station devices are distinguished as non-moving base station devices 200-1 and 200-3 and a moving base station device 200-2. The base station device 200-2 is a base station device that moves across a location registration area.

The base station device 200-2 is, for example, a base station device mounted on a vehicle such as a train. The base station device 200-2 moves while keeping a predetermined positional relationship with respect to the terminal device 100 possessed by an occupant of the vehicle. The predetermined positional relationship is a positional relationship between the base station device 200 and the terminal device 100 in a state in which the terminal device 100 possessed by the occupant of the vehicle has boarded the vehicle. Although the vehicle is assumed to be a train in the following description, the present invention is not limited thereto and it is only necessary for the vehicle to be a transportation facility such as a bus that moves with an occupant.

Also, although one management device 400 is illustrated in the example of the configuration illustrated in FIG. 1, it is only necessary to provide one management device 400 for a plurality of base station control devices 300 and the management device 400 may be configured in a plurality of devices. In the following description, in a case that a terminal device is not distinguished from another terminal device, it is simply referred to as a “terminal device 100”. In a case that a base station device is not distinguished from another base station device, it is simply referred to as a “base station device 200”. In a case that a base station control device is not distinguished from another base station control device, it is simply referred to as a “base station control device 300”.

The base station device 200, the base station control device 300, and the management device 400 form a mobile communication network. The base station device 200 is, for example, a base station device equipped with communication functions such as Long Term Evolution (LTE), and LTE-Advanced and the terminal device 100 is a mobile station device (user equipment (UE) equipped with communication functions such as LTE and LTE-Advanced. The base station control device 300 is, for example, a mobility management entity (MME).

The management device 400 is, for example, a home subscriber server (HSS) or a home location register (HLR). The MME and the HSS may be a single device or may be a system including one or more devices as the MME and one or more devices as the HSS.

Each of the base station devices 200 forms a cell and communicates with the terminal device 100 by forming a cell. The cell refers to a communication area formed according to radio waves transmitted by the base station device 200. The communication area is also referred to as a coverage area or a coverage. A cell is also used in a case that it refers to the base station device itself forming the cell and a frequency (also referred to as a carrier and a component carrier) of transmitted radio waves.

A cell ID is given to each of the cells. The cell ID is an identifier (identification information) for identifying a cell, and is an example of cell identification information for identifying a cell. The cell ID is, for example, a physical cell identifier (PCI), an E-UTRAN cell global identifier (ECGI), an eNB Identifier (eNB ID), or the like in LTE.

A plurality of cells including a cell corresponding to the base station device 200-1 form location registration area 1. A plurality of cells including a cell corresponding to the base station device 200-3 form location registration area 2. The location registration area is an area where a plurality of cells are grouped. The location registration area corresponds to a range in which a simultaneous paging process (a paging process) of the terminal device 100 is performed in a case that there is an incoming signal (a call connection request) for the terminal device 100. Location registration area 1 corresponds to a range in which the paging process is executed by the base station control device 300-1. Location registration area 2 corresponds to a range in which the paging process is executed by the base station control device 300-2.

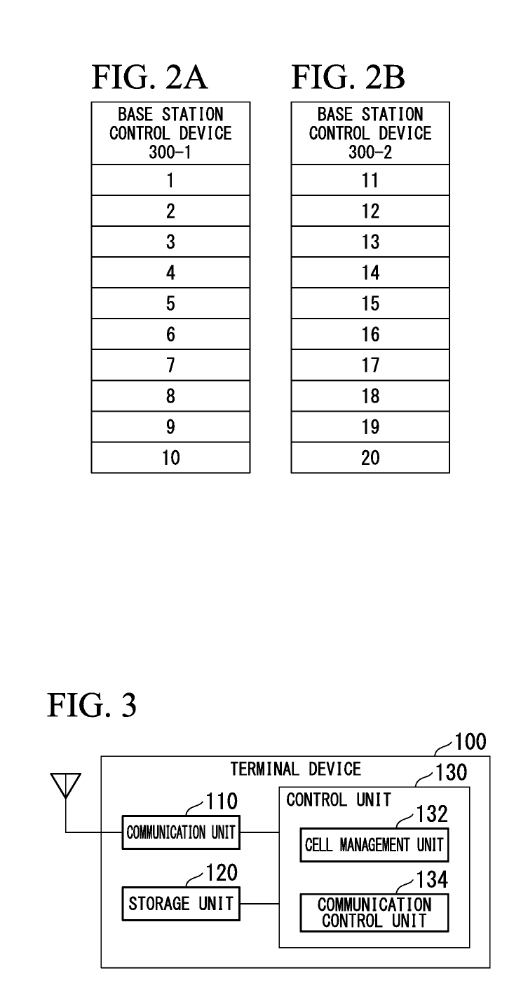

FIG. 2A and FIG. 2B are diagrams illustrating cell IDs assigned to each of the location registration areas, wherein FIG. 2A is a diagram illustrating a cell ID assigned to location registration area 1 (the base station control device 300-1) and FIG. 2B is a diagram illustrating a cell ID assigned to location registration area 2 (the base station control device 300-2). As illustrated in FIG. 2A, ten cell IDs “1” to “10” are assigned to location registration area 1. Each of the ten cell IDs “1” to “10” corresponds to cell identification information usable in location registration area 1. The base station control device 300-1 can perform a paging process using the cell ID assigned to location registration area 1. A cell ID different from the cell ID assigned to another location registration area is assigned to location registration area 2. Specifically, ten cell IDs “11” to “20” are assigned to location registration area 2. Each of the ten cell IDs “11” to “20” corresponds to cell identification information usable in location registration area 2. The base station control device 300-2 can perform a paging process using the cell ID assigned to location registration area 2.

Also, although ten cell IDs (the same number of cell IDs) are assigned to each of the base station control devices 300-1 and 300-2, the present invention is not limited thereto. The number of cell IDs that can be used by the base station control device 300 may depend on the capability of the base station control device 300. For example, in a case that the capability of the base station control device 300 is higher, more cell IDs can be assigned thereto.

As illustrated in FIG. 1, a cell ID=5 is assigned to the base station device 200-1 within location registration area 1. In a case that the base station device 200-2 is located in location registration area 1, the base station control device 300-1 assigns a cell ID=1 to the base station device 200-2. A cell ID=20 is assigned to the base station device 200-3 in location registration area 2. In a case that the base station device 200-2 has moved to location registration area 2, the base station control device 300-2 assigns a cell ID=11 to the base station device 200-2.

FIG. 3 is a block diagram illustrating an example of a configuration of the terminal device 100. The terminal device 100 includes, for example, a communication unit 110, a storage unit 120, and a control unit 130. The communication unit 110 includes a wireless communication interface for transmitting and receiving radio waves. The communication unit 110 transmits a transmission signal input from the control unit 130 as radio waves to the base station device 200. The communication unit 110 receives radio waves from the base station device 200 as a received signal and outputs the received signal to the control unit 130.

The storage unit 120 includes at least one hard disk drive (HDD), a flash memory, an electrically erasable programmable read only memory (EEPROM), a read only memory (ROM), a random access memory (RAM), or the like or a combination thereof. The storage unit 120 stores various types of information and programs related to the terminal device 100.

The control unit 130 controls various types of functions of the terminal device 100. For example, some or all of the functions of the terminal device 100 are implemented by executing various types of programs stored in the storage unit 120 using at least one processor such as a central processing unit (CPU) provided in the control unit 130. The control unit 130 includes, for example, a cell management unit 132 and a communication control unit 134.

The cell management unit 132 manages cell IDs of cells to which the terminal device 100 is connected. The cell management unit 132 acquires a cell ID transmitted by the base station device 200 as notification information using the communication unit 110 and stores the acquired cell ID using the storage unit 120.

The communication control unit 134 performs control related to communication with the base station device 200. The communication control unit 134 has a communication connection with the base station device 200 corresponding to the cell ID based on the cell ID stored in the storage unit 120. Specifically, for example, the communication control unit 134 performs control processes such as the establishment of connection with and disconnection from the base station device 200, a process related to a handover, and a process related to transmission and reception of user data.

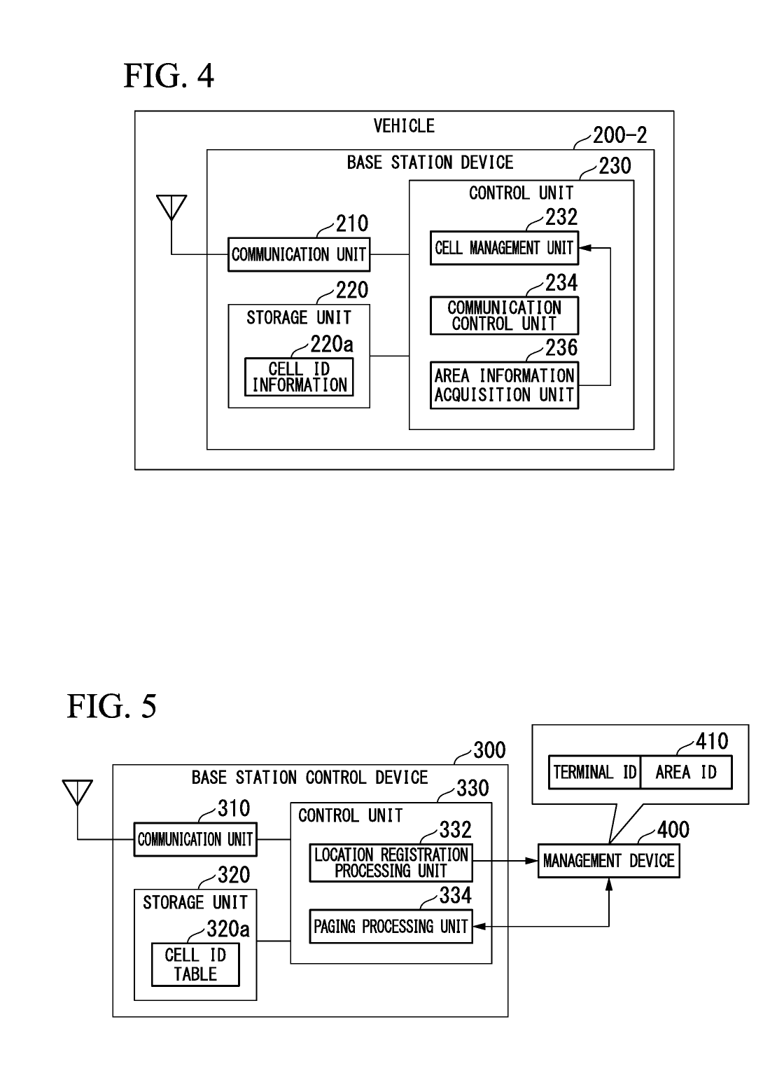

FIG. 4 is a block diagram illustrating an example of a configuration of the base station device 200-2. The base station device 200-2 includes, for example, a communication unit 210, a storage unit 220, and a control unit 230.

The communication unit 210 includes a wireless communication interface for transmitting and receiving radio waves. The communication unit 210 transmits a transmission signal input from the control unit 230 as radio waves to the terminal device 100.

The communication unit 210 receives radio waves from the terminal device 100 as a received signal and outputs the received signal to the control unit 230.

The storage unit 220 includes at least one HDD, a flash memory, an EEPROM, a ROM, a RAM, or the like, or a combination thereof. The storage unit 220 stores various types of information and programs related to the base station device 200-2. Specifically, the storage unit 220 stores information representing cell ID information 220a.

The cell ID information 220a is information representing a cell ID usable in a movement destination of the base station device 200-2 (a vehicle). Specifically, in a case that the base station device 200-2 moves from location registration area 1 to location registration area 2, for example, the cell ID information 220a is information indicating at least some cell IDs of information indicating cell IDs assigned to location registration area 2.

In a case that the base station device 200-2 moves across the location registration area, the base station device 200-2 acquires a usable cell ID from the base station control device 300 corresponding to the location registration area of the movement destination, and stores the acquired cell ID as the cell ID information 220a.

The base station device 200-2 may pre-store a cell ID usable in the location registration area within a range where the vehicle can move as the cell ID information 220a. For example, in a case that a traveling route is known in advance as in a train, the base station device 200-2 may store a cell ID usable in the location registration area including the traveling route as the cell ID information 220a. Specifically, in a case that the vehicle travels back and forth between location registration area 1 and location registration area 2, the base station device-200-2 may store information obtained by associating information for identifying the base station control device 300-1 or location registration area 1 with information indicating a cell ID assigned to the base station control device 300-1 or location registration area 1 as illustrated in FIG. 2A and information obtained by associating information for identifying the base station control device 300-2 or location registration area 2 with information indicating a cell ID assigned to the base station control device 300-2 or location registration area 2 as illustrated in FIG. 2B as the cell ID information 220a.

In a case that there are a plurality of vehicles passing through a certain location registration area, the cell ID information 220a is set so that a plurality of cell IDs are not used in the same location registration area at the same time in a plurality of base station devices 200 mounted on the plurality of vehicles. Specifically, a plurality of base station devices 200 belonging to the same location registration area may form a cell using the same cell ID in the same location registration area in non-overlapping time slots. That is, in a case that a plurality of base station devices 200 are not scheduled to enter a certain location registration area at the same time, the cell ID information 220a may be set so that each of the plurality of base station devices 200 is configured to use the same cell ID as those of the other base station devices 200. In a case that a plurality of base station devices 200 are scheduled to enter a certain location registration area at the same time, the cell ID information 220a may be set so that each of the plurality of base station devices 200 uses a cell ID different from those of the other base station devices 200. A time in a case that each vehicle is located in a location registration area and a location registration area where each vehicle is located at that time are known according to a schedule of a train or the like.

To minimize conflict of cell IDs, it is desirable that the storage unit 220 store information indicating that a cell ID is not currently being used. The information indicating that the cell ID is not currently being used is, for example, an unused flag. The unused flag is information added in correspondence with a cell ID which is not currently being used in the cell ID information 220a. To generate an unused flag, the base station device 200-2 receives information indicating a currently used cell ID or a currently unused cell ID from the base station control device 300 in a case that the location registration area has been changed.

The control unit 230 controls various types of functions of the base station device 200-2. Some or all of the functions provided in the base station device 200-2 may be implemented, for example, by executing various types of programs stored in the storage unit 220 by at least one processor such as a CPU provided in the control unit 230. The control unit 230 includes, for example, a cell management unit 232, a communication control unit 234, and an area information acquisition unit 236. The non-moving base station devices 200-1 and 200-3 are different from the base station device 200-2 in that the non-moving base station devices 200-1 and 200-3 do not include the area information acquisition unit 236.

The cell management unit 232 manages the cell ID set in the base station device 200-2. The communication control unit 234 performs control related to communication with the terminal device 100 within a coverage area of the base station device 200-2. Specifically, the communication control unit 234 performs control processes such as the establishment of connection with and disconnection from the terminal device 100, a process related to a handover, and a process related to transmission/reception of user data. Further, the communication control unit 234 includes the cell ID of the base station device 200-2 in the notification information and causes the communication unit 210 to provide a notification of the cell ID.

The area information acquisition unit 236 acquires information about the location registration area to which the base station device 200-2 belongs. The area information acquisition unit 236 is, for example, a Global Positioning System (GPS) receiver (not illustrated) provided in the base station device 200. The area information acquisition unit 236 detects location information of the base station device 200-2. The control unit 230 detects a location registration area corresponding to a current location of the base station device 200-2 by comparing the detected location information with the location information of the location registration area pre-stored in the storage unit 220. Also, the area information acquisition unit 236 may be the communication unit 210 receiving a notification from another device or an inter-device interface such as a universal serial bus (USB) (not illustrated) if it is possible to acquire information about the location registration area to which the base station device 200-2 belongs.

The area information acquisition unit 236 identifies a location of a train based on the information from a train operation management system and the control unit 230 may detect a location registration area based on the identified location. The train operation management system is a system that manages a traveling situation (a location, a course, etc.) of a train, for example, based on a planned schedule. The area information acquisition unit 236 may acquire information indicating a current clock time, and the control unit 230 may detect a location registration area of the base station device 200-2 based on a current clock time. In this case, the control unit 230 may associate clock time information in an operation schedule of the vehicle equipped with the base station device 200-2 with a location registration area, compare the current clock time with the clock time information, and detect the location registration area.

In a case that a change in the location registration area to which the base station device 200-2 belongs has been detected, the control unit 230 controls the cell management unit 232 such that the cell ID is changed. The cell management unit 232 changes the cell ID.

FIG. 5 is a block diagram illustrating an example of configurations of the base station control device 300 and the management device 400. The base station control device 300 includes, for example, a communication unit 310, a storage unit 320, and a control unit 330.

The communication unit 310 includes a wireless communication interface for transmitting and receiving radio waves. The communication unit 210 transmits a transmission signal input from the control unit 330 as radio waves to the base station device 200. The communication unit 310 receives radio waves from the base station device 200 as a received signal and outputs the received signal to the control unit 330. Although the communication unit 310 communicates with the base station device 200 using a wireless connection, the present invention is not limited thereto and the communication unit 310 may perform communication with the base station device 200 using a wired connection.

The storage unit 320 includes at least one HDD, a flash memory, an EEPROM, a ROM, a RAM, or the like, or a combination thereof. The storage unit 320 stores various types of information and programs related to the base station control device 300. Specifically, information indicating a cell ID table 320a including a cell ID assigned to the base station control device 300 is stored in the storage unit 320. For example, as illustrated in FIG. 2A and FIG. 2B, the cell ID table 320a is information in which information indicating the assigned cell ID is associated with information for identifying the base station control device 300.

The control unit 330 controls various types of functions of the base station control device 300. For example, some or all of the functions of the base station control device 300 may be implemented by executing various types of programs stored in the storage unit 320 by at least one processor such as a CPU provided in the control unit 330. The control unit 330 includes, for example, a location registration processing unit 332 and a paging processing unit 334.

The management device 400 is, for example, a storage function installed in the HSS. The location registration processing unit 332 performs a location registration process on the terminal device 100 using information received from the base station device 200. Specifically, the location registration processing unit 332 causes the location registration information to be stored in the management device 400. Although the location registration processing unit 332 associates a terminal ID with an area ID and causes them to be stored in the management device 400, the present invention is not limited thereto and the cell ID and the area ID to which the terminal device 100 belongs may be associated with the terminal ID and stored in the management device 400.

In a case that the base station device 200-2 has moved across the location registration area, the management device 400 associates the terminal ID with the area ID after the change based on the location registration information received from the base station control device 300. Thereby, the management device 400 constructs a database 410 in which the terminal ID and the area ID are associated. In the database 410, the terminal ID may be associated with the cell ID of the base station device 200 to which the terminal device 100 is connected in addition to the area ID.

In a case that downlink data such as an incoming signal for the terminal device 100 has been generated, the paging processing unit 334 performs a paging process of paging the terminal device 100 in response to a request of the management device 400. In a case that the base station control device 300 corresponds to the location registration area to which the terminal device 100 belongs, the management device 400 requests the base station control device 300 to perform a paging process related to an incoming signal for the terminal device 100. In accordance with reception of the request, the paging processing unit 334 simultaneously requests the base station device 200 under control of the base station control device 300 to perform a paging process related to an incoming signal for the terminal device 100.

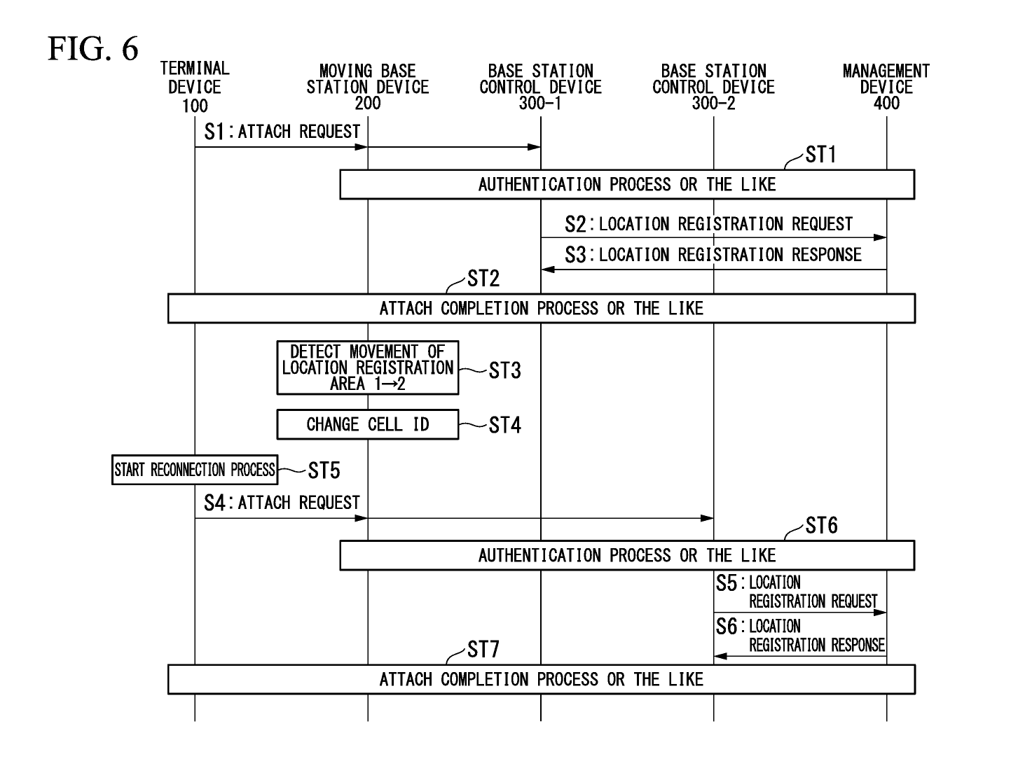

Hereinafter, a sequence in a case that the base station device 200 moves from location registration area 1 to location registration area 2 in the mobile communication system 1 will be described. FIG. 6 is a diagram illustrating an example of a sequence in the mobile communication system 1. In the following description, the base station device 200 is assumed to be a moving base station device and the terminal device 100 is assumed to be held by an occupant of the vehicle.

For example, in a case that the terminal device 100 is powered on, the terminal device 100 performs a cell search and transmits an attach request (S1) to the base station device 200 of a cell detected by the cell search. The attach request may be read as a location registration request. The attach request is transmitted to the base station control device 300-1 via the base station device 200.

The base station control device 300-1 performs a user authentication process, a confidential process on data, or the like (step ST1). Thereafter, the base station control device 300-1 transmits a location registration request (S2) including location registration information to the management device 400. Based on the location registration information, the management device 400 associates the terminal ID of the terminal device 100 with the area ID of the location registration area to which the terminal device 100 belongs. Thereafter, the management device 400 transmits a location registration response (S3) to the base station control device 300-1. Thereafter, the mobile communication system 1 performs an attach completion process including the remaining process of an attach process or the like (step ST2).

The base station device 200 is assumed to have detected that the base station device 200 has moved from location registration area 1 to location registration area 2 (step ST3). In this case, the base station device 200 changes a cell ID to be used for communication of the terminal device 100 from a cell ID corresponding to location registration area 1 to a cell ID corresponding to location registration area 2 with reference to the cell ID information 220a (step ST4). In this case, the cell ID corresponding to location registration area 1 corresponds to first cell identification information usable in the location registration area before the change and the cell ID corresponding to location registration area 2 corresponds to second cell identification information usable in the location registration area after the change.

Specifically, for example, as illustrated in FIG. 1, the base station device 200 changes its own cell ID by designating the cell ID “11” as the second cell identification information from among cell IDs other than a cell ID already used in another base station device 200-3 among a plurality of cell IDs that can be used by the base station device 200 located within location registration area 2 after the change. Also, although the base station device 200 itself changes the cell ID, the present invention is not limited thereto and the base station control device 300 may independently change the cell ID of the base station device 200. For example, the base station control device 300 may change the cell ID of the base station device 200 using the base station device 200 by transmitting an instruction to the base station device 200.

In a case that the cell ID has been changed in the base station device 200, for example, the terminal device 100 starts a reconnection process in accordance with detection of interruption of communication with the base station device 200 (step ST5). The terminal device 100 acquires the changed cell ID of the base station device 200 by executing the cell search. The terminal device 100 transmits an attach request (S4) to the base station device 200 using the changed cell ID of the base station device 200. The attach request is transmitted to the base station control device 300-2 via the base station device 200.

The base station control device 300-2 performs a user authentication process, a confidential process on data, and the like (step ST6). Thereafter, the base station control device 300-2 transmits a location registration request (S5) including location registration information to the management device 400. Based on the location registration information, the management device 400 associates a terminal ID of the terminal device 100 with an area ID of location registration area 2 to which the terminal device 100 belongs. Thereafter, the management device 400 transmits a location registration response (S3) to the base station control device 300-2. Thereafter, the mobile communication system 1 performs an attach completion process including the remaining process of the attach process and the like (step ST7).

As described above, the mobile communication system 1 causes the terminal device 100 to execute the reconnection process in a case that the base station device 200 moves from location registration area 1 to location registration area 2.

Thereby, the mobile communication system 1 can shorten a period in which a location registration area where the terminal device 100 is actually located is different from a location registration area of the terminal device 100 registered in the management device 400. As a result, according to the mobile communication system 1, even in a case that an outgoing signal from the terminal device 100 or an incoming signal to the terminal device 100 is generated, because a location registration area corresponding to the location of the terminal device 100 is correctly registered in the management device 400, it is possible to cause the terminal device 100 to perform communication and telephone conversation with an opposite device.

Also, according to the mobile communication system 1, in a case that the cell ID of the base station device 200 is changed, it is possible to change a cell ID other than a cell ID already used in another base station device 200 among a plurality of cell IDs that can be used by a base station device located within the location registration area after the change to a cell ID usable in the location registration area after the change. Thereby, according to the mobile communication system 1, even in a case that the base station device 200 moves, it is possible to prevent a cell ID from being redundantly used with other base station devices 200 in a location registration area of the movement destination.

Further, according to the mobile communication system 1, each of a plurality of base station devices 200 stores a cell ID corresponding to the scheduled location registration area to which the base station device 200 itself belongs and a plurality of base station devices 200 that do not simultaneously belong to a predetermined location registration area form a cell using the same cell ID in a case that they belong to the predetermined location registration area. Thereby, according to the mobile communication system 1, one cell ID can be shared by a plurality of base station devices 200.

### Second Embodiment

A second embodiment will be described below. Also, parts that are the same as those of the first embodiment are denoted by the same reference signs and detailed description thereof will be omitted. The second embodiment is different from the first embodiment in that a base station device notifies a terminal device of a change in a location registration area during movement across a location registration area. This difference will be mainly described below.

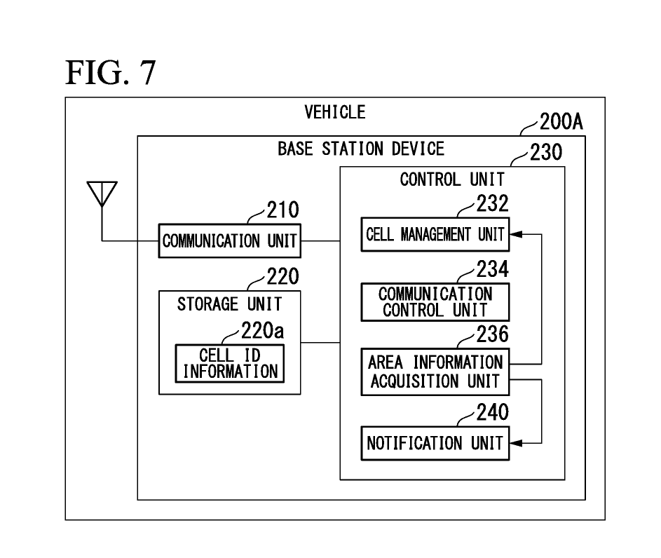

FIG. 7 is a block diagram illustrating an example of a configuration of a base station device 200A according to the second embodiment. The base station device 200A includes a notification unit 240. The notification unit 240 provides a notification to the terminal device 100 based on a result of detecting a location registration area.

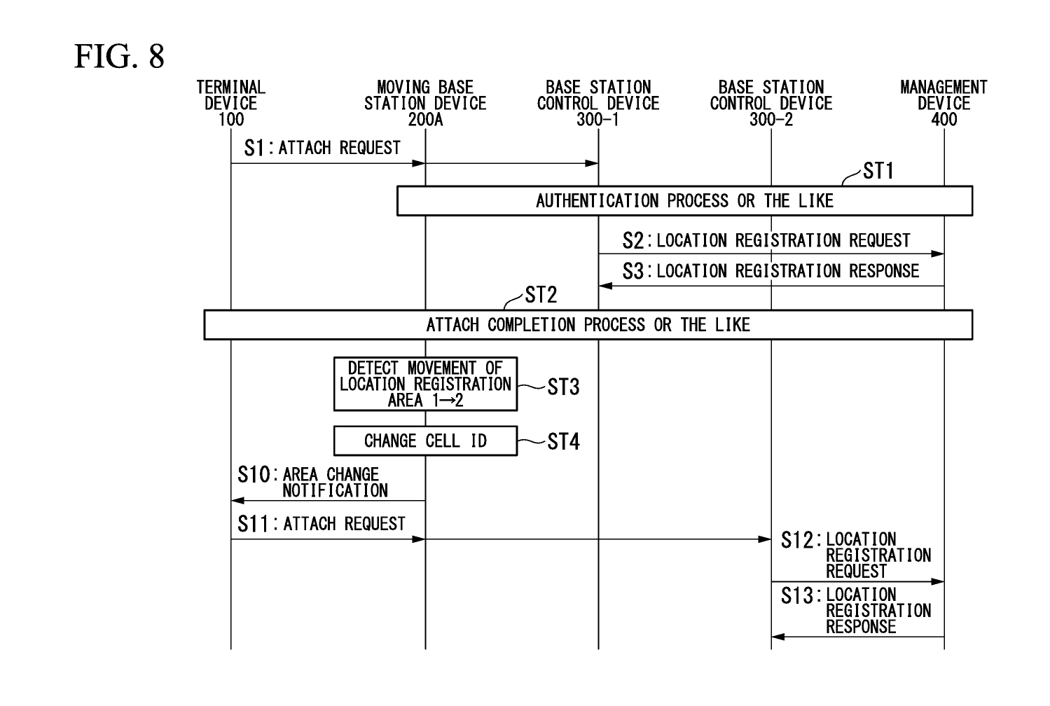

FIG. 8 is a diagram illustrating another example of the sequence in the mobile communication system 1.

In a case that the base station device 200A has detected movement from location registration area 1 to location registration area 2 (step ST3), the base station device 200A changes a cell ID to be used for the communication of the terminal device 100 from a cell ID corresponding to location registration area 1 to a cell ID corresponding to location registration area 2 (step ST4). The notification unit 240 of the base station device 200A transmits an area change notification (S10) to all terminal devices 100 connected to the base station device 200A.

In accordance with reception of the area change notification (S10), the terminal device 100 transmits an attach request (S11) to the base station device 200A. In accordance with reception of the attach request (S11), the base station device 200A transmits a location registration request to the base station control device 300-2 of a movement destination.

In accordance with reception of the location registration request based on the location registration request (S11), the base station control device 300-2 transmits a location registration request (S12) to the management device 400. In accordance with reception of the location registration request (S12), the management device 400 associates a terminal ID of the terminal device 100 transmitting the location registration request (S11) with an area ID of location registration area 2 after the change. The management device 400 transmits a location registration response (S13) to the base station control device 300-2.

According to the mobile communication system 1 that executes such a sequence, in a case that the base station device 200 has moved across the location registration area, because the terminal device 100 is notified of the area change notification, it is possible to further shorten a period in which a location registration area where the terminal device 100 is actually located is different from a location registration area of the terminal device 100 registered in the management device 400.

Also, according to the mobile communication system 1, it is possible to distribute a processing burden on the base station device 200A to the terminal device 100.

### Third Embodiment

Hereinafter, a third embodiment will be described. Also, parts that are the same as those of the above-described embodiment are denoted by the same reference signs and detailed description thereof will be omitted. The third embodiment is different from the above-described embodiment in that a base station device provides a notification of a cell ID usable in a location registration area of a movement origin and a cell ID usable in a location registration area of a movement destination in a cell formed by the base station device during movement across the location registration area. Also, the third embodiment is different from the above-described embodiment in that a cell ID of the base station device 200 is changed in a case that the base station device has issued a handover instruction to a terminal device 100. This difference will be mainly described below.

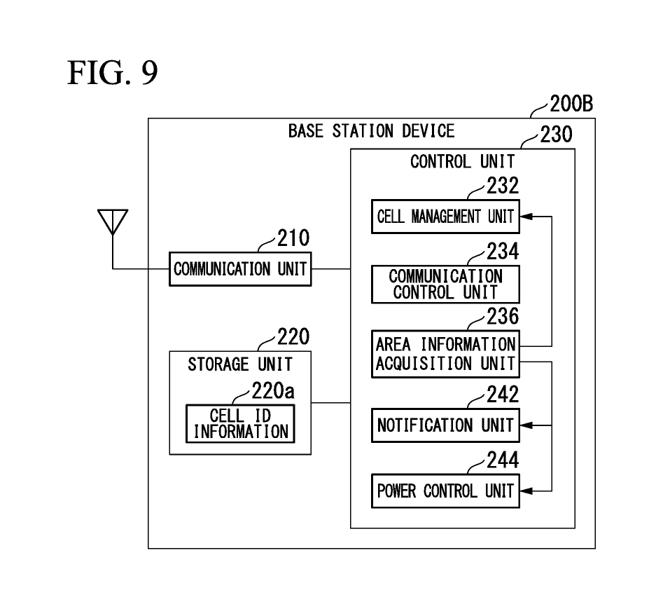

FIG. 9 is a block diagram illustrating an example of a configuration of a base station device 200B according to the third embodiment. The base station device 200B includes a notification unit 242 and a power control unit 244. In a case that the base station device 200 moves across the location registration area, the notification unit 242 provides a notification of a cell ID usable in a location registration area of a movement destination. In a case that the base station device 200 moves across the location registration area, the power control unit 244 causes the power of radio waves to be transmitted using a cell ID used in a location registration area of a movement origin to be decreased.

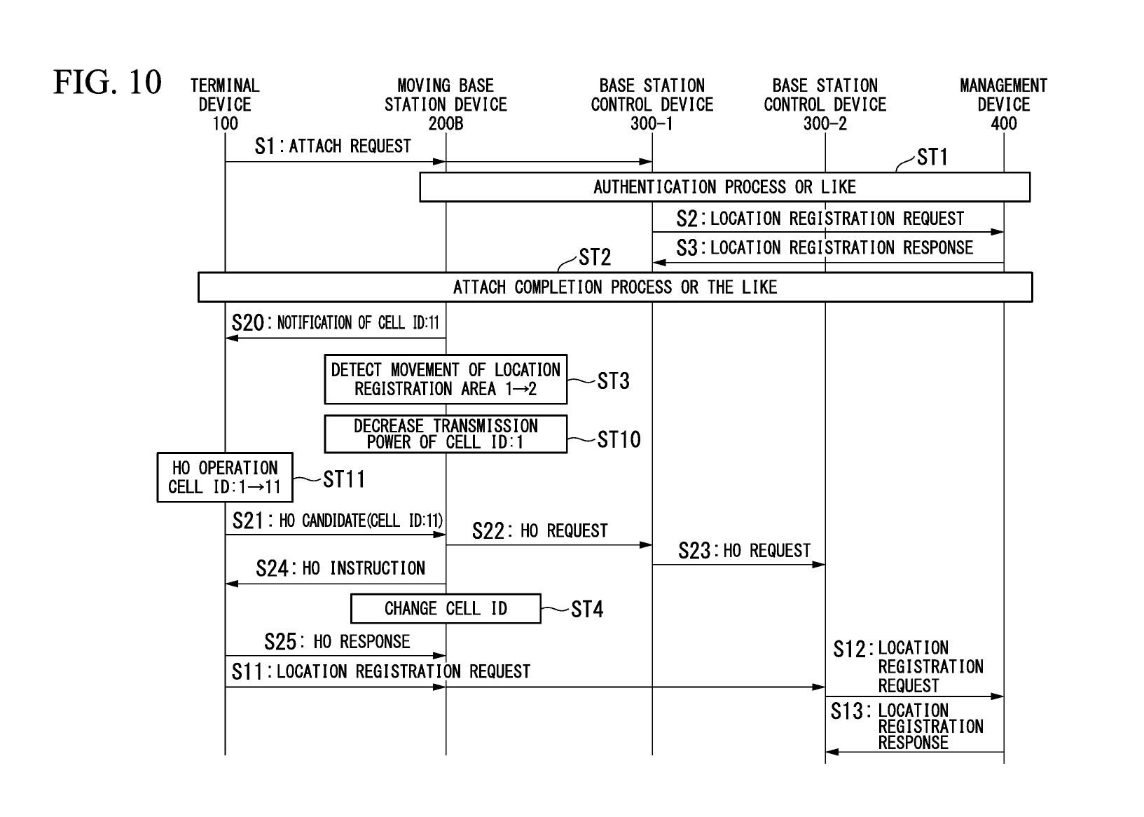

FIG. 10 is a diagram illustrating another example of a sequence in the mobile communication system 1.

The notification unit 242 transmits notification information (S20) before the base station device 200B moves from location registration area 1 to location registration area 2. The base station device 200B transmits information indicating a cell ID=11 usable in location registration area 2 of the movement destination of the base station device 200B as notification information.

In a case that the base station device 200B has detected movement from location registration area 1 to location registration area 2 (step ST3), the power control unit 244 causes the power of radio waves to be transmitted using a currently used cell ID=1 to be decreased (step ST10). The power control unit 244 causes the power of radio waves to be transmitted using a cell ID=1 to be decreased to a standard or less. The standard is, for example, low power as a trigger of a handover in the terminal device 100.

The terminal device 100 performs a handover (HO) operation of changing the cell ID from 1 to 11 in accordance with detection of the fact that the power of radio waves to be transmitted using the currently used cell ID=1 has decreased (step ST11). The terminal device 100 transmits information indicating the cell ID=11 as information (S21) indicating a handover candidate to the base station device 200B.

In accordance with reception of the information (S21) indicating the handover candidate, the base station device 200B transmits a handover request (S22) to the base station control device 300-1 corresponding to the cell ID=1. In accordance with reception of the handover request (S22), the base station control device 300-1 transmits a handover request (S23) to the base station control device 300-2 corresponding to the cell ID=11.

After the handover request (S22) is transmitted, the base station device 200B transmits a handover instruction (S24) to the terminal device 100 and changes a cell ID to be used for the communication of the terminal device 100 from a cell ID corresponding to location registration area 1 to a cell ID corresponding to location registration area 2 (step ST4).

In accordance with reception of the handover instruction (S24), the terminal device 100 changes the cell ID from 1 to 11 and transmits a handover response (S25) to the base station device 200B. Next, the terminal device 100 transmits a location registration request (S11) to the base station device 200B using the cell ID=11.

According to the mobile communication system 1 that executes such a sequence, in a case that the base station device 200B moves across the location registration area, a notification of the cell ID to be used in the location registration area of the movement origin is provided from the base station device 200B. Thereby, according to the mobile communication system 1, the handover operation in the terminal device 100 can be performed smoothly. Although the base station device 200B transmits the notification information before moving across the location registration area, the present invention is not limited thereto and the base station device 200B may transmit the notification information immediately after moving across the location registration area.

Also, according to the mobile communication system 1, because the power of radio waves using the cell ID used in the location registration area of the movement origin is decreased, it is possible to cause the terminal device 100 to quickly start the handover operation after movement across the location registration area.

### Fourth Embodiment

A fourth embodiment will be described below. Also, parts that are the same as those of the above-described embodiment are denoted by the same reference signs and detailed description thereof will be omitted. In the fourth embodiment, a vehicle includes a plurality of base station devices. In a mobile communication system 1, a base station device corresponding to a cell ID used in a location registration area of a movement origin performs communication with a terminal device 100 before a vehicle moves across a location registration area and a base station device corresponding to a cell ID used in a location registration area of a movement destination performs communication with the terminal device 100 after the vehicle moves across the location registration area. This point will be mainly described below.

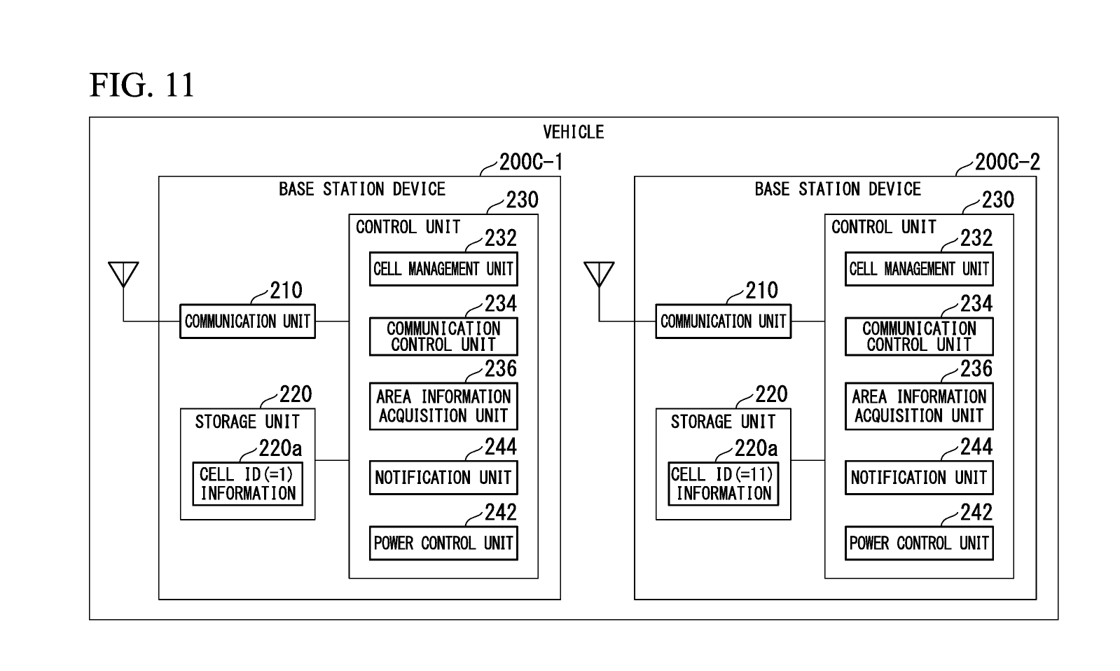

FIG. 11 is a block diagram illustrating an example of a configuration of the vehicle according to the fourth embodiment. The vehicle includes a first base station device 200C-1 and a second base station device 200C-2. In a storage unit 220 of the first base station device 200C-1, at least information indicating a cell ID=1 used in the location registration area of the movement origin is stored as cell ID information 220a. In a storage unit 220 of the second base station device 200C-2, at least information indicating a cell ID=11 used in the location registration area of the movement destination is stored as cell ID information 220a.

One of the first base station device 200C-1 and the second base station device 200C-2 communicates with the terminal device 100. In a case that the terminal device 100 is located in location registration area 1 where the cell ID=1 can be used, the first base station device 200C-1 communicates with the terminal device 100. In a case that the terminal device 100 is located in location registration area 2 where the cell ID=11 can be used, the second base station device 200C-2 communicates with the terminal device 100.

Each of the communication control unit 234 of the first base station device 200C-1 and the communication control unit 234 of the second base station device 200C-2 performs switching between ON and OFF of the communication unit 210, for example, based on a result of detecting the location registration area. Thereby, one of the first base station device 200C-1 and the second base station device 200C-2 can communicate with the terminal device 100.

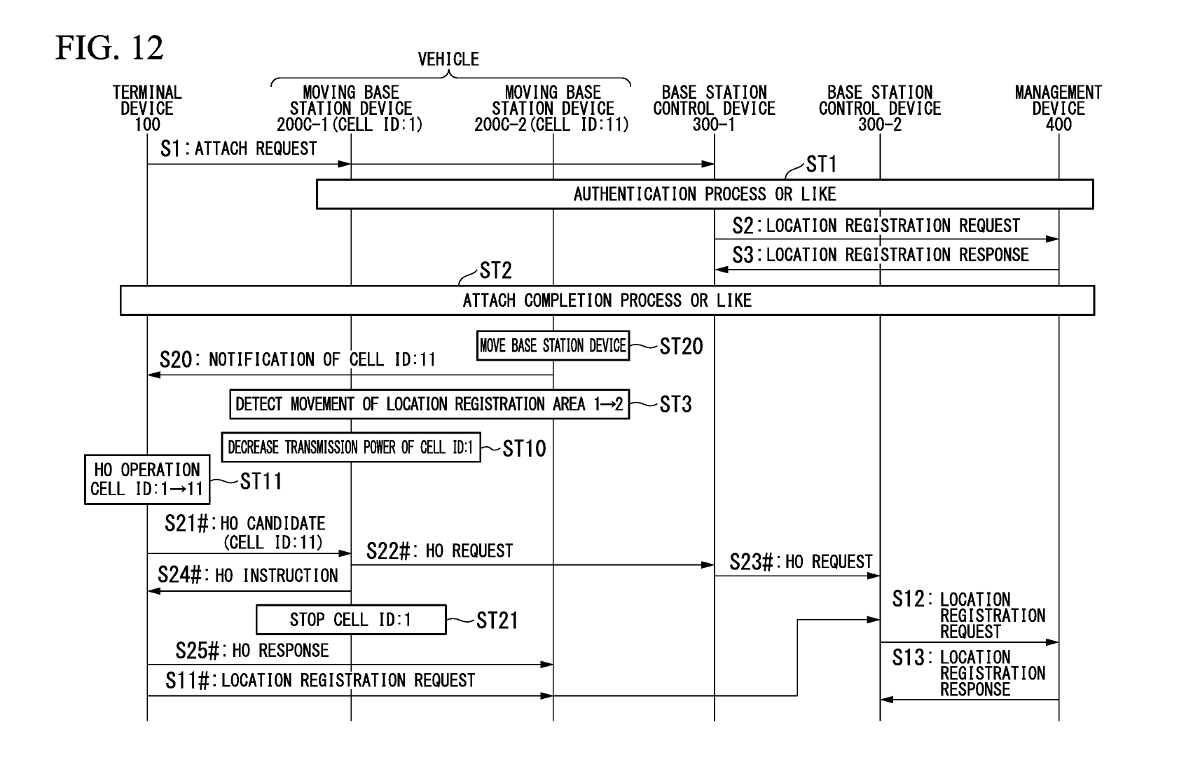

FIG. 12 is a diagram illustrating another example of the sequence in the mobile communication system 1.

The second base station device 200C-2 is activated before the vehicle moves from location registration area 1 to location registration area 2 (step ST20). For example, the second base station device 200C-2 causes the activation of the second base station device 200C-2 to be started before a clock time obtained by advancing an activation time of the second base station device 200C-2 from a clock time at which the vehicle enters location registration area 2. The clock time at which the vehicle enters location registration area 2 is, for example, a scheduled time at which the vehicle enters location registration area 2 acquired from an operation management system.

After the second base station device 200C-2 is activated, the notification unit 242 of the second base station device 200C-2 transmits notification information (S20) to the terminal device 100 connected to the first base station device 200C-1. The second base station device 200C-2 transmits information indicating a cell ID=11 usable in location registration area 2 of the movement destination as notification information.

The first base station device 200C-1 and the second base station device 200C-2 detect that the vehicle has moved from location registration area 1 to location registration area 2 (step ST3). In this case, the power control unit 244 of the first base station device 200C-1 causes the power of radio waves to be transmitted using the currently used cell ID=1 to be decreased (step ST10).

The terminal device 100 performs a handover (HO) operation of changing the cell ID from 1 to 11 in accordance with detection of the fact that the power of radio waves to be transmitted using the currently used cell ID=1 has been decreased (Step ST11). The terminal device 100 transmits information indicating the cell ID=11 to the first base station device 200C-1 as information (S21#) indicating a handover candidate.

In accordance with reception of the information (S21#) indicating the handover candidate, the first base station device 200C-1 transmits a handover request (S22#) to the base station control device 300-1 corresponding to the cell ID=1. In accordance with reception of the handover request (522#), the base station control device 300-1 transmits a handover request (S23#) to the base station control device 300-2 corresponding to the cell ID=11.

After the handover request (S22#) is transmitted, the first base station device 200C-1 transmits a handover instruction (S24#) to the terminal device 100 and stops communication using the cell ID=1 (step ST21).

In accordance with reception of the handover instruction (S24#), the terminal device 100 changes a cell ID to be used for communication from 1 to 11 and transmits a handover response (S25#) to the second base station device 200C-2. Next, the terminal device 100 transmits a location registration request (S11#) to the second base station device 200C-2 using the cell ID=11. The second base station device 200C-2 transmits a location registration request to the base station control device 300-2 based on the location registration request (S11#).

According to the mobile communication system 1 that executes such a sequence, the first base station device 200C-1 that performs communication using the cell ID used in location registration area 1 of the movement origin and the second base station device 200C-2 that performs communication using the cell ID used in location registration area 2 of the movement destination are provided. Thereby, it is possible to cause the terminal device 100 to reliably perform a handover by performing a simple operation of switching the base station device to be activated.

### MODIFIED EXAMPLES

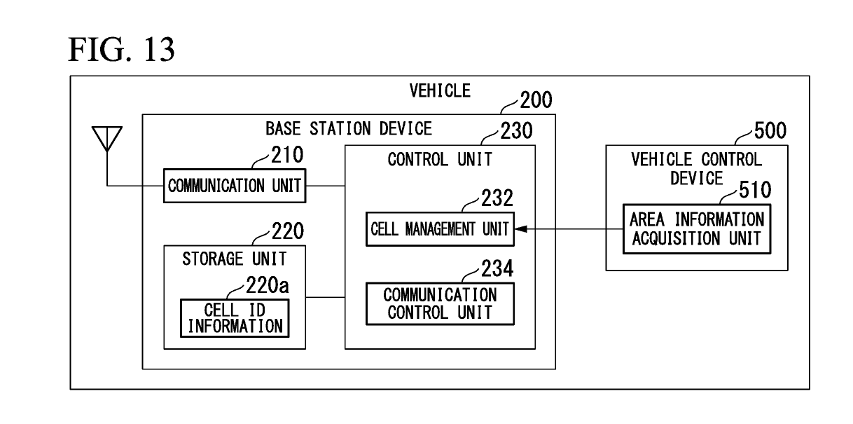

Although the base station device 200 detects that the base station device 200 has moved across the location registration area in the above-described embodiment, the present invention is not limited thereto, and a device other than the base station device 200 may detect a change in a location registration area. FIG. 13 is a block diagram illustrating a modified example.

In the modified example, a vehicle control device 500 mounted on a vehicle includes an area information acquisition unit 510. The area information acquisition unit 510 identifies a current location of the vehicle based on, for example, location information of the vehicle received from an operation management system of the vehicle or information from a GPS. The vehicle control device 500 performs vehicle speed control or the like, for example, based on the location of the vehicle. The vehicle control device 500 compares location information of a preset location registration area with a current location of the vehicle to detect that the vehicle has moved across the location registration area.

Also, programs operating in the terminal device 100, the base station device 200, the base station control device 300, and the management device 400 according to an aspect of the present invention may be programs for controlling one or more processors such as CPUs (programs for causing computers to function) so that functions shown in the above-described embodiments and modified examples related to an aspect of the present invention are implemented. Information handled by each of these devices may be temporarily stored in the RAM at the time of processing and may be stored in various types of storages such as a flash memory and an HDD, read by the CPU as needed, and corrected/written thereafter.

Also, a part or all of each of the base station control device 300 and the management device 400 according to the above-described embodiments or modified examples may be configured to be implemented by a computer including one or more processors. In this case, the control functions thereof may be implemented by recording a program for implementing the control functions on a computer-readable recording medium and causing a computer system to read and execute the program recorded on the recording medium.

Also, it is assumed that the “computer system” described here is a computer system embedded in the terminal device 100, the base station device 200, the base station control device 300, and the management device 400 and includes an operating system (OS) and hardware such as peripheral devices. Also, the “computer-readable recording medium” refers to a storage device including a flexible disk, a magneto-optical disc, a ROM, a portable medium such as a CD-ROM, and a hard disk embedded in the computer system.

Further, the “computer-readable recording medium” is assumed to include a computer-readable recording medium for dynamically holding a program for a short time as in a communication line in a case that the program is transmitted via a network such as the Internet or a communication circuit such as a telephone circuit and a computer-readable recording medium for holding the program for a predetermined time as in a volatile memory inside the computer system including a server and a client in a case that the program is transmitted. Also, the above-described program may be used to implement some of the above-described functions. Further, the program may implement the above-described functions in combination with a program already recorded on the computer system.

Also, a part or all of each of the terminal device 100, the base station device 200, the base station control device 300, and the management device 400 according to the above-described embodiments and modified examples may be implemented as large scale integration (LSI) that is a typical integrated circuit or a chip. Each of the functional blocks of the terminal device 100, the base station device 200, the base station control device 300, and the management device 400 according to the above-described embodiments and modified examples may be individually implemented by a chip or a part or all thereof may be integrated into a chip. Also, a technique of forming an integrated circuit is not limited to LSI, and may be implemented by a dedicated circuit and/or a general-purpose processor. Also, in a case that the technology of an integrated circuit with which LSI is replaced emerges with the advancement of semiconductor technology, the integrated circuit based on the technology may be used.

Although embodiments and modified examples as an aspect of the present invention have been described above in detail with reference to the drawings, specific configurations are not limited to the embodiments and the modified examples and changes in design and the like are also included without departing from the scope of the present invention. Also, in an aspect of the present invention, various changes are possible within the range described in the claims. An embodiment obtained by appropriately combining technical means disclosed in each of the different preferred embodiments is included in the technical scope of the present invention. Also, a configuration obtained by exchange of elements described in the above-described embodiments and modified examples and having similar effects is also included.

For example, an aspect of the present invention may be implemented by combining some or all of the above-described embodiments and modified examples.

### EXPLANATION OF REFERENCES

100 Terminal device

132 Cell management unit

134 Communication control unit

200 Base station device

220 Storage unit

232 Cell management unit

234 Communication control unit

234, 236 Area information acquisition unit

238 Registration unit

300 Base station control device

320 Storage unit

320a Cell ID table

332 Location registration processing unit

400 Management device

410 Database

What is claimed is:

1. A mobile communication system, comprising:
a terminal device;
a base station device configured to communicate with the terminal device by forming a cell; and
an area detection unit configured to detect a location registration area to which the base station device belongs,
wherein, in a case that the area detection unit has detected a change in the location registration area to which the base station device belongs, the base station device is configured to change cell identification information of the cell formed by the base station device from first cell identification information usable in a location registration area before the change to second cell identification information usable in a location registration area after the change.

2. The mobile communication system according to claim 1, wherein the second cell identification information is selected from cell identification information other than cell identification information already used in other base station devices among a plurality of pieces of cell identification information that are able to be used by the base station device located within the location registration area after the change.

3. The mobile communication system according to claim 1, wherein a plurality of base station devices belonging to the same location registration area form a cell using the same cell identification information in the location registration area in time slots that do not overlap.

4. A mobile communication system, comprising:
a terminal device;
a base station device configured to communicate with the terminal device by forming a cell; and
an area detection unit configured to detect a location registration area to which the base station device belongs,
wherein, in a case that the area detection unit has detected a change in the location registration area to which the base station device belongs, the base station device is configured to form a new cell using cell identification information usable in a location registration area after the change.

5. A base station device for communicating with a terminal device by forming a cell, the base station device comprising:
an area information acquisition unit configured to acquire information about a location registration area to which the base station device belongs;
a communication unit configured to communicate with the terminal device; and
a control unit,
wherein, in a case that a change in a location registration area to which the base station device belongs has been detected, the control unit is configured to change cell identification information of the cell formed by the base station device from first cell identification information usable in a location registration area before the change to second cell identification information usable in a location registration area after the change based on the information acquired by the area information acquisition unit.

6. The base station device according to claim 5, wherein the control unit is configured to notify the terminal device connected to the base station device of the change via the communication unit in a case that the cell identification information has been changed.

7. The base station device according to claim 5, wherein the control unit is configured to provide a notification of the second cell identification information via the communication unit in a case that the cell identification information has been changed.

8. The base station device according to claim 5, wherein the control unit is configured to cause the communication unit to decrease power of radio waves to be output to a standard or less in a case that the change in the location registration area to which the base station device belongs has been detected.

9. A vehicle, comprising:
the base station device according to claim 5.

10. A vehicle equipped with a base station device for communicating with a terminal device by forming a cell,
wherein, in a case that a location registration area to which the base station device belongs has been changed, the base station device is configured to form a new cell using cell identification information usable in a location registration area after the change.

11. A terminal device for use in a mobile communication system including the terminal device and a base station device for communicating with the terminal device by forming a cell, the terminal device comprising:
a reception unit configured to receive information based on a change in a location registration area to which the terminal device belongs from the base station device connected to the terminal device; and
a change unit configured to change cell identification information for communicating with the base station device from first cell identification information usable in a location registration area before the change to second cell identification information usable in a location registration area after the change based on the information received by the reception unit.
